(19) United States
(12) Patent Application Publication
(10) Pub. No.: US 2004/0030619 A1
(43) Pub. Date: Feb. 12, 2004

(54) System and method for calculating transaction-based taxes

(76) Inventors: Patricia L. Stokes, Brooklyn, NY (US); David E. Prouhet, O'Fallon, IL (US)

Correspondence Address: RADER, FISHMAN & GRAUER PLLC, 39533 WOODWARD AVENUE, SUITE 140, BLOOMFIELD HILLS, MI, 48304-0610, US

(21) Appl. No.: 10/431,982

(22) Filed: May 8, 2003

Related U.S. Application Data
(63) Continuation-in-part of application No. 10/252,226, filed on Sep. 23, 2002.
(60) Provisional application No. 60/349,180, filed on Jan. 16, 2002.

(51) Int. Cl. G06F 17/60

(52) U.S. Cl. 705/31

(57) ABSTRACT

The invention is a system or method (collectively the “system”) for calculating transaction-based taxes, such as use tax and sales tax. Some of the data used to generate a tax calculation relate solely to the particular transaction. Other data can be potentially be used for several different transactions, and need only be collected and stored once. The tax calculator can generate tax calculations using both transaction data and non-transaction data, although such data can originate and be stored through different mechanisms and sources. The system can be configured to implement and enforce in an automated manner, the tax conclusions and selections provided by the merchant.

### RELATED APPLICATIONS

This Continuation-In-Part application claims the benefit of the provisional application titled “INTERNET SALES TAX DETERMINATION METHOD” (Ser. No. 60/349,180) filed on Jan. 16, 2002 and the utility application titled “TAX CALCULATOR” (Ser. No. 10/252,226) filed on Sep. 23, 2002.

### BACKGROUND OF INVENTION

The invention relates generally to systems and methods for calculating transaction-based taxes.

The proper calculation of sales taxes, use taxes, and other transaction-based taxes (collectively “transaction taxes” or simply “taxes”) is not a trivial task. A single transaction can be taxed by several different government authorities in a complex hierarchy of relationships. For the purposes of transaction taxes, there are currently over 7,600 jurisdictions (“tax authorities”) in the United States. Multiple jurisdictions can simultaneously exert taxing authority on the same transaction. For example, a single transaction in New York City can result in state, county, city, and local (e.g. zone) taxes. However, different jurisdictions classify transactions differently, resulting in a wide variety of different tax exemptions, tax rates, and other tax characteristics. For example, orange juice can be classified as a taxable fruit in one jurisdiction while considered a non-taxable beverage in another jurisdiction. Each jurisdiction can have distinctly different exemption rules, tax rates, and maximum tax rates. The prior art does not provide an effective solution for this problem. Moreover, the prior art does not provide an affirmative suggestion or motivation to resolve this problem.

Remote transactions (transactions where the buyer and seller are not at the same location) can further complicate the accurate calculation of transaction taxes. Common examples of remote transactions can include transactions that occur via telephone, mail order, the Internet, or some other communication mechanism by which the parties involved in the transaction are located in different jurisdictions. If a merchant has a “substantial presence” or “nexus” in a particular state (e.g. jurisdiction), then that merchant is subjected to that states special rules concerning their obligation to collect transaction taxes. A merchant may be required to collect and remit a sales tax or possibly even act as the purchaser's agent for the purposes of collecting and remitting any use taxes owed by the purchaser as a result of the transaction. Even though use taxes and sales taxes (collectively “transaction taxes) are usually complementary taxes, the nuances of their application differ from state to state and these rules can change regularly through state legislation and case law. In summary, the calculation of transaction taxes can be very complex.

Complicating matters even further are the different ways various states determine which state's laws should apply for tax purposes. Some states classify the jurisdiction in which the transaction originates as the relevant jurisdiction for transactional tax purposes (“origination-based” or “point of sale” jurisdictions). Other states are more concerned with the destination for the goods when choosing which state's laws should apply (“destination-based” or “point of delivery” jurisdictions). Further complicating matters is the issue of freight. In some jurisdictions, delivery charges are taxable, while in other jurisdictions they are not. The interactions between such conflicting policies is a significant challenge for merchants, governments, and consumers, as well as any system intending to calculate transactional taxes.

With respect to remote transactions, there is no motivation or suggestion to improve the accuracy of tax calculations. Some companies simply identify the highest tax rate out of all the jurisdictions in which they have a “nexus”, and charge that high rate on all transactions-resulting in an overcharging of taxes. Such companies have no motivation to improve the accuracy of their tax calculations. Existing techniques teach away from an inexpensive and accurate tool for transaction-based tax calculations.

Costs associated with accurately calculating a transaction tax for a particular transaction can easily exceed the financial value of the collected transaction tax. Conducting business over a wide range of overlapping jurisdictions (there are over 7,600 jurisdictions in the United States) requires access to frequently updated databases, which is a very expensive proposition. Smaller business entities are particularly unable or unwilling to incur such costs, yet the vast majority of remote transactions involve sellers that are small businesses.

Competitive pressures between online merchants and retailers is consistently increasing. Antitrust laws substantially prevent efforts by such merchants and retailers to pool together their resources and engage in cooperative and collective activities. However, it would be desirable if the costs of maintaining the infrastructure for tax calculation could be spread out among more than one merchant or retailer.

Changes in tax rules are frequent. Political bodies at all levels of government face budgetary issues that are often reflected in tax rate changes. An effective tax calculator would need to incorporate all updates across the more than 7,600 jurisdictions that exist in the United States. Tax rules overlap between jurisdictions, and the ways in which tax rates interrelate are also subject to frequent changes. It would be desirable if a solution for tax calculation could isolate changes to the software in only one location, instead of needing to distribute the solution to all users. However, there is no motivation or suggestion in the existing art to consolidate all tax rules across all jurisdictions for multiple combinations of merchants, customers, and products.

The data storage and processing power needed to accurately calculate transaction-based taxes can be a significant burden on the computational device(s) used to calculate the transaction-based tax. It would be desirable if persons or entities desiring to calculate taxes did not need to install significant computer code on their machines in order to calculate transaction-based taxes. There is no motivation or suggestion in the art to achieve these desirable goals.

Much of the data necessary for computing transaction-based taxes requires legal assessments of certain facts or contexts. It may be desirable if such legal assessments were made by human beings, entered into the system, and applied in an automated way across multiple transactions. It may be desirable for an automated system to incorporate tax rules embodying the intelligence of tax laws generally, and embedded intelligence relating to the situation of a particular merchant. It may be desirable for a merchant to have the ability to change their tax criteria and rules, and have those changes permeate throughout the system with respect to that particular merchant. It may be desirable for a tax calculator to be able to respond to requests for tax calculations in a way that is not observable to the potential purchaser initiating the transaction. The prior art does not include any motivation or suggestions at achieving such goals. In fact, existing techniques affirmatively teach away from such objectives.

### SUMMARY OF INVENTION

The invention is a system or method (collectively the “system”) for calculating transaction-based taxes, such as use tax, sales tax, and other transaction-based taxes (collectively “transaction taxes” or simply “taxes”).

The system can be configured using a setup page residing on a first computer system. A transaction page residing on a second computer system can invoke a tax calculation program residing on the first computer system. The setup page provides for the receipt and capture of various merchant tax rules which can be configured by the merchant. The transaction page provides for the receipt of various transaction characteristics that relate to the particular transaction. The tax calculation program creates a tax calculation from the various applicable merchant rules and transaction characteristics.

Some of the data or characteristics used to generate a tax calculation relate solely to the particular transaction (“transaction data” or “transaction characteristic”). Other types of data and characteristics such as merchant data (a “merchant characteristic”) and subscription data (a “subscription characteristic”) can be utilized by the tax calculator for more than one transaction. The tax calculator can generate tax calculations using a wide variety of different combinations of one or more transaction characteristics and one or more non-transaction characteristics.

In some embodiments of the system, a transaction subsystem can be configured to capture a transaction characteristic from an online shopping cart. A subscription subsystem (which can also be referred to as a setup subsystem or a merchant subscription) can be used to capture a “nexus” (e.g. “substantial presence”) characteristic that can be applied to multiple different tax calculations performed on behalf of a particular merchant by a tax calculator.

In some embodiments, different interfaces can be configured to receive different types of data. A transaction interface can be configured to receive transaction characteristics and a merchant interface (which can also be referred to as a subscription interface or a setup interface) can be configured to receive non-transaction characteristics which can potentially apply to more than one transaction.

In some embodiments, all legal conclusions and analysis are supplied by the merchant in configuring the system. In other embodiments, the system itself can be used to generate legal conclusions from underlying facts.

In some embodiments of the system, a merchant or other entity enters subscription characteristics during a setup process while transaction characteristics are entered into the tax calculator on a transaction-by-transaction basis.

### BRIEF DESCRIPTION OF THE DRAWINGS

The embodiments of the present invention will be described in detail, with reference to the following figures, wherein:

FIG. 1 is a block diagram illustrating one example of some of the elements of a system or method for tax calculation.

FIG. 2 is a process-flow diagram illustrating one example of how information for a particular tax calculation can originate from various data sources.

FIG. 3 is a block diagram illustrating one example of a subsystem-level view of a system or method for tax calculation.

FIG. 4 is a block diagram illustrating a different example of a subsystem-level view of a system or method for tax calculation.

FIG. 5 is web site diagram illustrating an example of a home page for an Application Service Provider (ASP) embodiment of the system or method for tax calculation.

FIGS. 6a and 6b are collectively a web site diagram illustrating an example of a merchant page, along with some examples of functionality relating to merchants and flexibility relating to merchant business rules.

FIG. 7 is web site diagram illustrating an example of an administrator page along with some examples of functionality that can be performed by the administrator of the system or method for tax calculation.

FIG. 8 is a flow chart illustrating one example of a process for capturing transaction data from a merchant web site and some subsequent processing that can be performed.

FIG. 9 is flow chart illustrating one example of processing exemptions and finalizing database transactions.

FIG. 10 is a flow chart illustrating a second example of how a system or method for tax calculation can be invoked by a transaction.

FIG. 11 is a flow chart illustrating a third example of how a system or method of tax calculation can be invoked by a transaction.

FIG. 12 is a flow chart illustrating a login and setup process that can include a nexus selection and the finalization of tax rules.

FIG. 13 is a flow chart of the startup process that can include the online acceptance of a license agreement with the ASP.

FIG. 14 is a flow chart illustrating an example of a tax calculation in the context of a remote online transaction.

FIG. 15 is a database diagram illustrating one example of how exemption information can be stored at jurisdictional hierarchy that is four levels deep.

FIG. 16 is a database diagram illustrating one example of how Merchant, Address, and Tax Authority data can be stored.

### DETAILED DESCRIPTION OF THE EMBODIMENTS

### I. INTRODUCTION

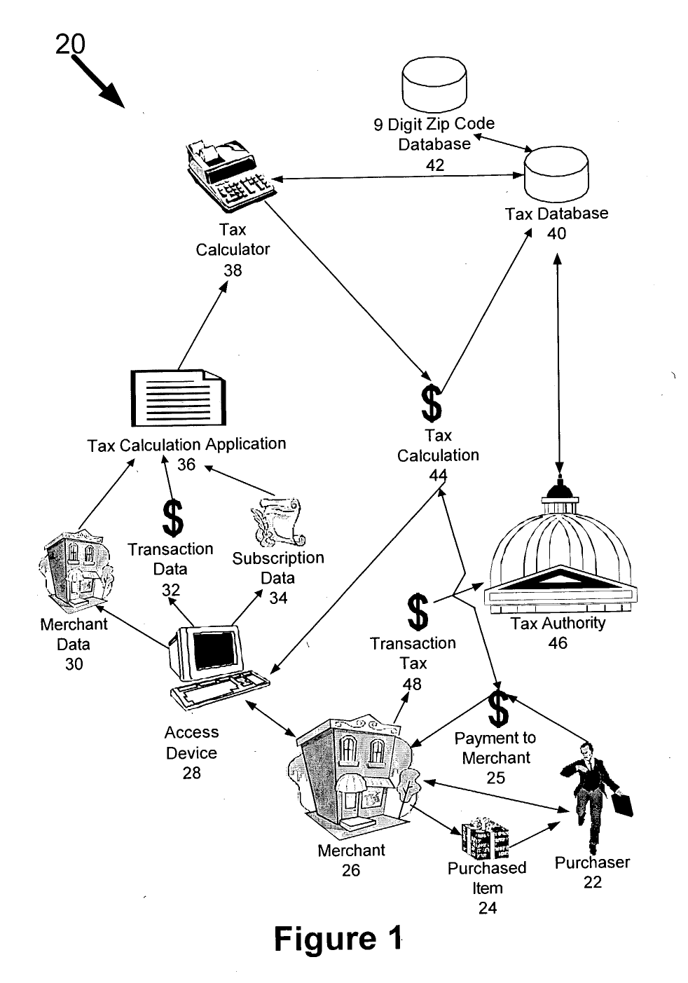

FIG. 1 illustrates an example of a tax calculating method and system (collectively the “system”) 20. The system 20 can be used to calculate sales tax, use tax, or any other transaction-based tax (collectively “transaction tax” or simply “tax”). In a preferred embodiment of the system 20, the legal analysis and judgment (collectively “tax law expertise”) used to generate tax calculations are supplied by the merchant utilizing the system 20. The system 20 can then apply and enforce the tax law expertise in an automated fashion without human intervention. In alternative embodiments, the system 20 can be configured to incorporate expert systems, artificial intelligence and other embedded intelligence technologies (collectively “embedded intelligence”) for the purposes of tax law expertise. In embedded intelligence embodiments, the system 20 itself can apply tax law expertise to the relevant underlying facts in an automated fashion without human intervention.

A. Transactions

Transactions typically consist of purchase transactions between a buyer (purchaser) and a seller (merchant). Transactions can also include rent-to-own transactions, leases, bailment arrangements, consignments, and any other contractual exchange of consideration (collectively a “transaction”) that can potentially result in a transaction tax 48. Transactions include face-to-face transactions as well as remote transactions. Remote transactions can occur via: telephone (both land lines and wireless); mail or a parcel service (“mail order”); video conferencing; computer networks such as intranets, extranets, the Internet, an EDI (electronic data interchange) mechanism or other form of computer network (collectively “network”), or through any other mechanism or process by which transactions can occur without a face to face exchange between the parties.

In a preferred embodiment, transactions are initiated on a transaction server by a purchaser 22 interacting with the transaction server through a purchase interface, such as a Web page

B. Purchaser

One of the parties to a transaction can be a purchaser 22. The variety of purchasers 22 that can be processed by the system 20 coincides with the variety of transactions that can be processed by the system 20. Thus, the purchaser 22 can be: the buyer in a sale transaction; the buyer in a rent-to-own transaction; a lessee in a lease transaction; a bailee in a bailment arrangement; the possessor in a consignment; or any other person, organization, partnership, corporation, or other entity that receives a good or service in a transaction.

In a preferred embodiment, the purchaser 22 is uses a Web browser as a purchase interface to access the transaction server of a merchant 26.

C. Purchased Item

A purchased item 24 is the contractual consideration of the transaction that is received by the purchaser 22. The variety of purchased items 24 that can be processed by the system 20 can vary as widely as the types of transactions. Purchased items 24 can be any product, good, service, or a combination of goods and services (collectively “purchased items” 24), that can potentially result in a transaction tax 48. In addition to one-time exchanges, purchased items 24 can also be ongoing forms of consideration such as subscriptions or leases.

D. Merchant

A merchant 26 is any person, organization, partnership, corporation, or any other entity (collectively “merchant”), engaged in the transaction with the purchaser 22. The merchant 26 provides consideration in the form of the purchased item 24 to the purchaser 22 in exchange for a payment 25 to the merchant 26 from the purchaser 22. Merchants 26 can be located at a location in the physical world, at a virtual location on a network, or in both physical and virtual locations. Merchants 26 can have one or more locations, in or more jurisdictions. Many merchants 26 function internationally. Just as the system 20 can function with respect to a wide variety of transactions, a wide variety of merchants 26 can also be incorporated into the system 20.

In a preferred embodiment, the merchant 26 uses a transaction server to create transactions based on interactions with purchasers 22 that occur through a purchaser interface. In a preferred embodiment, the transaction server automatically invokes a remote tax server under the control of an Application Service Provider (“ASP”) that includes a tax calculation application 36. The tax server then forwards on a tax calculation 48 back to the transaction server. The purchaser 22 thus need not even be aware that the tax server is being invoked by the transaction server.

E. Payment

A payment 25 from the purchaser 22 to the merchant 26 for a purchased item 24 can be in the form of cash, credit card, debit card, cyber cash, online payment services (such as ®PAYPAL), check or other negotiable instrument, a loan, or any other payment mechanism. Typically, the payment 25 will include any transaction tax 48 that is due in addition to ancillary charges such as shipping and handling in the case of the shipment of a package. In many embodiments of the system 20, the transaction tax 48 is calculated before the transaction the purchaser 22 and merchant 26 is finalized so that an accurate transaction tax 48 value can be included in the payment 25 required as a result of the transaction. In some embodiments, the payment 25 to the merchant 26 triggers a ping to the tax database 40 that the transaction is good, so that all relevant data can be saved. In an ASP embodiment of the system 20 discussed below, the per transaction charge of the ASP can also be incorporated into the payment 25 by the purchaser 22 to the merchant 26.

F. Access Device

The merchant 26 interacts with the system 20 through an access device 28. In some embodiments of the system 20, the system 20 incorporates a network for facilitating the exchange of information. In a network embodiment of the system 20 that incorporates the Internet, an intranet, an extranet, or some other form of network (collectively “network”), the access device 28 is any device capable of interacting with a network. General purpose computers such as laptops, desktop computers, mainframes, mini-computers, work stations, and other devices can be access devices 28. Programmable logic devices, non-general purpose computers, personal digital assistants (PDAs), cell phones, land-line phones, satellite pages, a wide range of wireless devices, and any other device capable of communicating information can potentially be used as access devices 28 by the system 20.

The system 20 can include many different access devices 28 as alternatives for the merchant 26. In some embodiments, two or more access devices 28 are used in combination with respect to the same data. For example, the system 20 could be configured so that the merchant 28 phones in information via a conventional land line telephone. A computer with voice recognition technology can then convert the information into a form that is more easily processed by the system 20.

In some embodiments, different access devices 28 are used to capture different types of data. For example, in online merchant 26 embodiments, a shopping cart on the web site of the merchant 26 can transparently capture data that is specific to the transaction itself (transaction data). A website for an application service provider (ASP) can be used by the merchant to 26 to provide information relating to the merchant 26 (such as jurisdictions in which the merchant 26 has a nexus or “substantial presence”) that is not limited to an individual transaction. The ASP website can also be used to set the terms of the subscription service provided to the merchant 26. The ASP can also be referred to as a third party administrator (TPA). In such an embodiment, the access device 28 can be the transaction server that purchasers 22 interact with through the merchant's 26 Web page.

The merchant 26 can interact with the tax server housing the tax calculation application 36 in various different ways through various different interfaces. A setup interface can be used to configure characteristics such as ongoing business rules that apply to more than one transaction. A transaction interface can be used to automatically supply the tax server with transaction data. With respect to interactions between merchants 26 and purchasers 22, a purchase interface such as a merchant 26 web page can be used to capture purchaser 22 inputs and use those inputs to create transaction characteristics on the transaction server, the server than can then automatically invoke the tax server using the purchaser inputs to invoke the appropriate processing.

G. Data

There is a potentially wide variety of different data that the merchant 26 can send to a tax calculation application 36 for subsequent processing. Some data relates specifically to the transaction itself (such as the actual shipping cost), and must be submitted by the access device 28 each time a tax calculation is to be performed. Such data can be referred to as transaction data 32 or transaction characteristics 32. Other types of data (non-transaction data) are utilized in each tax calculation, but only need to be entered once into the system 20. Examples of data that does not necessarily change from transaction to transaction with respect to a particular merchant are merchant data (merchant characteristics) 30 and subscription data (subscription characteristics) 34.

Information relating to the merchant 26 can be referred to as merchant characteristics 30 or merchant data 30. Information relating to the transaction can be referred to as transaction characteristics 32 or transaction data 32. Information relating to subscriptions can be referred to as subscription characteristics 34 or subscription data 34. Other categories of information can be incorporated into the system 20. Similarly, business rules can exist with respect to the different types of data. Merchant business rules can be configured by the merchant to implement merchant 26 preferences. Transaction business rules can key off of various transaction characteristics to trigger certain outcomes. For example, if a merchant 26 believes that a particular type of product is not properly taxable, the merchant 26 can define that product as exempt using the setup interface of the system 20.

1. Merchant Characteristics

A wide range of merchant characteristics 30 can be incorporated into the system 20. Merchant characteristics 30 can include any data that relates to the specific merchant 30 that can be useful in generating tax calculations for the transactions of the specific merchant 30.

One category of merchant data 30 is nexus information (e.g. information relating to a “substantial presence” in a jurisdiction). Tax calculations relating to a specific transaction in a particular jurisdiction will differ depending on whether the merchant 26 has a nexus with respect to the particular jurisdiction. In a preferred embodiment, the merchant 26 makes their own legal judgments in determining whether or not a merchant 26 has a nexus in a particular jurisdiction. In such embodiments, the merchant 26 inputs their nexus selection(s) through the access device 28. In alternative embodiments, the system 20 can be configured to automatically determine nexus jurisdictions for a particular merchant 26 based on automated tax intelligence embedded into the system 20. In embodiments where the system 20 makes nexus determinations, all of the data relevant to making those determinations constitute merchant data 30.

Merchant characteristics 30 can include a wide variety of data that is not nexus data. For example, tax exemptions can be based on the identity of the merchant 26. The location of the merchant 26 is another example of a merchant characteristic 30. Merchants 26 can have multiple locations. In some embodiments, locations are in the form of mailing addresses. However, the system 20 can incorporate future developments in positioning technologies, and may incorporate different forms of location information, such as latitude and longitude coordinates, or TCIP address information.

2. Transaction Characteristics

A wide range of transaction data 32 can be incorporated into the system 20. Transaction data 32 can include all data and characteristics that are specific to a particular transaction. Transaction data 32 can include but is not limited to the characteristics of: the particular purchased item(s) 24, the classification of the particular purchased item(s) 24, the identity of the purchaser 22 (such as a purchaser identifier), the jurisdiction in which the transaction occurred, the price of the particular purchased item(s) 24, ancillary costs relating to the purchased item(s) 24 such as the actual shipping cost, real-time currency conversion information, real-time shipment tracking information, exemption status, and any other information relating to the transaction that is potentially useful in generating a tax calculation 44.

The location of the transaction (which could be the location of the merchant 26, the location purchaser 22, or some other location depending on the applicable tax rule) is another example of a transaction characteristic 32. In some embodiments, locations are in the form of mailing addresses. However, the system 20 can incorporate future developments in positioning technologies, and may incorporate different forms of location information, such as latitude and longitude coordinates, TCP/IP information, or potentially any other means for identifying a location. The system 20 can include transparent and non-transparent links to various shipper sites, such as Federal Express, UPS, the U.S. Postal Service, etc. to obtain real-time shipping information. Transaction characteristics can also include the date/time of the transaction in the applicable jurisdiction. The existence of a “Max Tax” for a transaction involving multiple purchased items 24 can also constitute a transaction characteristic to the extent that it impacts the tax calculation 44 for the particular transaction.

3. Subscription Characteristics

Embodiments of the system 20 in which an application service provider (ASP) provides tax calculation services to one or more merchants 26 can include a wide range of subscription data 34. Subscription data 34 can include all data and characteristics that define the subscription relationship between an ASP and the merchant 26. Subscription data 34 can include but is not limited to: a subscription identifier, a subscription contract, a per transaction charge, a flat fee charge, a selection of jurisdiction-specific tax databases, a contract expiration date, and any other information that could potentially be useful for an ASP or a merchant 26 in the providing of tax calculation services.

H. Tax Calculation Application

The system 20 provides information to a tax calculation application 36 through one or more access devices 28 as described above. The information provided to the tax calculation application (the “application”) 36 can include merchant characteristics 30, transaction characteristics 32, subscription characteristics 34, and any other categories of information.

In networked-based embodiments, the application 36 is housed on a server that is potentially accessible from any client device on the network. In Internet embodiments, the application 36 is configured to be accessible from a web browser on any type of computer with Internet access. In a preferred Internet embodiment, the application 36 provides the means by which merchant data 30 and subscription data 34 are inputted into the system 20. In a preferred Internet embodiment, the application 36 provides a means for configuring the capture of transaction data 32 directly from the website of the merchant 26. Thus, a purchaser 22 can provide transaction data 32 to the application 36 without being aware that the merchant 26 is accessing the services of a third party.

In a preferred embodiment, the tax calculation application 36 resides on a tax server under the control of an ASP. Merchants 26 who are customers of the ASP can configure their transaction servers to automatically invoke the tax calculation application 36, and retrieve the results of the calculation in a way that is transparent to the purchaser 22.

I. Tax Calculator

A tax calculator 38 is the engine underlying the application 36 that actually generates a tax calculation 44 utilizing information received from the application 36 and information on one or more tax databases 40. In some embodiments, the tax calculator 38 is fully embedded in the application 36 and thus not distinct from, the application 36. In some embodiments, the tax calculator 38 and tax database 40 are highly integrated, and thus are not distinct from each other.

The tax calculator 38 can be implemented in a wide variety of information technology configurations. In a preferred embodiment, the tax calculator (or simply “calculator”) 38 is written in an object-oriented programming language such as the JAVA® language created by Sun Microsystems. Alternative embodiments may incorporate a wide variety of different programming languages, programming techniques, and information technology components. Any mechanism capable of implementing the process of calculating the transaction tax 44 (described below), is capable of being utilized by the system 20 as a tax calculator 38.

J. Databases

The system 20 can include various mechanisms for the storage of data. In a preferred embodiment, databases such as relational or object oriented databases are used. In alternative embodiments, the storage mechanisms might be flat files, spreadsheets, software objects, various data structures, or any other storage mechanism.

The primary database (or series of databases) used by the system 20 can be referred to as a tax database 40. The tax database can be used for storing both inputs and outputs of the system 20. For example, each tax calculation 44 uses various inputs to generate each tax calculations 44, and those inputs can be stored along with the corresponding tax calculations 44 on the database 40. Data that is reused multiple times, such as merchant characteristics 30 and subscription characteristics 34, can be stored once on the tax database 40 and accessed by the tax calculator 38 as desired. The tax database 40 can also store tax rate information, classification and exemption information relating to categories of purchased items 24, and other information that is not inputted into the system 20 by the merchant 26 or the purchaser 22. In an ASP embodiment of the system 20, the ASP manages and controls the tax database 40. In some embodiments, the tax database 40 can be configured to interface directly with a tax authority 46 from one or more jurisdictions in setting up the various tax rules that apply to a particular jurisdiction. In some embodiments of the system 20 where the ASP is actually responsible for reporting and/or collecting transaction taxes 48 on behalf of the tax authority 46, the tax database can be configured to store additional merchant 30 and purchaser 22 information to assist in such functionality.

In order to facilitate quick and accurate tax calculations, the system 20 can also include a zip code database 42 populated with the information necessary for identifying the nine-digit zip code from the transaction data 32 that includes a transaction location. The nine-digit zip code, in contrast to the shorter five-digit zip code, can be used to precisely identify the relevant jurisdiction(s) of a transaction. The zip code database 42 can be accessed by the tax calculator 38 through a wide variety of different configurations, including through the tax database 40 as illustrated in FIG. 1. The system 20 can incorporate other geography-based databases to identify relevant jurisdictions. The system 20 is sufficiently flexible to incorporate changes in tax laws, and the taxing practices of national, state, county, city, local, and other tax authorities 46.

In embodiments of the system 20 that include a transaction server and a tax server, the ASP's database resides on the tax server, and whatever database component is used internally by the merchant 26 resides on the transaction server. The tax database 40 is the means by which automated business rules that are capable of being customized and configured by merchants 26 are supported by the system 20.

K. Tax Calculation

A tax calculation 44 can be generated by the tax calculator 38 used by the system 20 before or after a transaction between the purchaser 22 and merchant 26 has been formalized such that it is a legally binding contract. In a preferred embodiment, the tax calculation 44 is generated before the transaction is completed, so that the payment 25 required by the purchaser 22 to complete the transaction can be accurately disclosed to the purchaser 22 before the purchaser 22 is asked to commit to the transaction. The tax calculation 44 can be in a wide variety of different currencies or other financial measurements.

L. Tax Authority

The system 20 can incorporate a wide variety of different tax authorities, including potentially international, national, state, county, city, local (e.g. zone), and other government entities capable of exerting taxes on a transactions. The system 20 is highly flexible, and can be configured to adapt to changes in tax laws and governmental policies relating to transaction taxes 48. In some embodiments of the system 20, tax authorities 46 interact directly with the tax rules stored in the tax database 40. In some embodiments of the system 20, each transaction tax 48 that is incurred is automatically reported to the tax authority 46 without human intervention by the system 20. In some embodiments, the system 20 automatically collects the transaction tax 48 without human intervention on behalf of one or more various tax authorities 46.

Tax authorities can be in hierarchical relationships with each other. These relationships include characteristics relating to geography. For example, a state may be composed of various counties and cities, and cities can be broken down into smaller units referred to as zones. One method of zone identification is a nine digit zip code.

M. Transaction Tax

The transaction tax 48 is the amount of tax owed to one or more tax authorities 46 as the result of the transaction. In some embodiments, the amount of the transaction tax 48 is reported to the various tax authorities 46 by the system 20. In some of those embodiments, the system 20 can actually collect the transaction tax 48 in an electronic form (such as using cyber cash, a credit or debit card number, an electronic payment mechanism such as ®PAYPAL, or some other mechanism). The transaction tax 48 is typically a sales or use tax, but the system 20 is sufficiently flexible to include other types of transaction-based taxes. In some ASP embodiments of the system 20, the fee for the ASP is added the payment 25 required by the purchaser 22.

In some embodiments of the system 20, the tax database 40 is pinged after a transaction is finalized, triggering the storage of all relevant data in the database 40. In a preferred embodiment of the system 20, the system 20 takes into account the “Max Tax” rules for multiple line-item transactions, if applicable, for the appropriate jurisdiction.

### II. DATA SOURCES

As discussed above, the system 20 can incorporate information from a wide variety of different information categories. Some information, such as transaction characteristics 32 relate to the specific transaction and do not apply outside the scope of the specific transaction. Other information, such as merchant characteristics 30 and subscription characteristics 34 can potentially be re-used for a voluminous number of different transactions. These distinctions can be reflected in the components and processes used by the system 20.

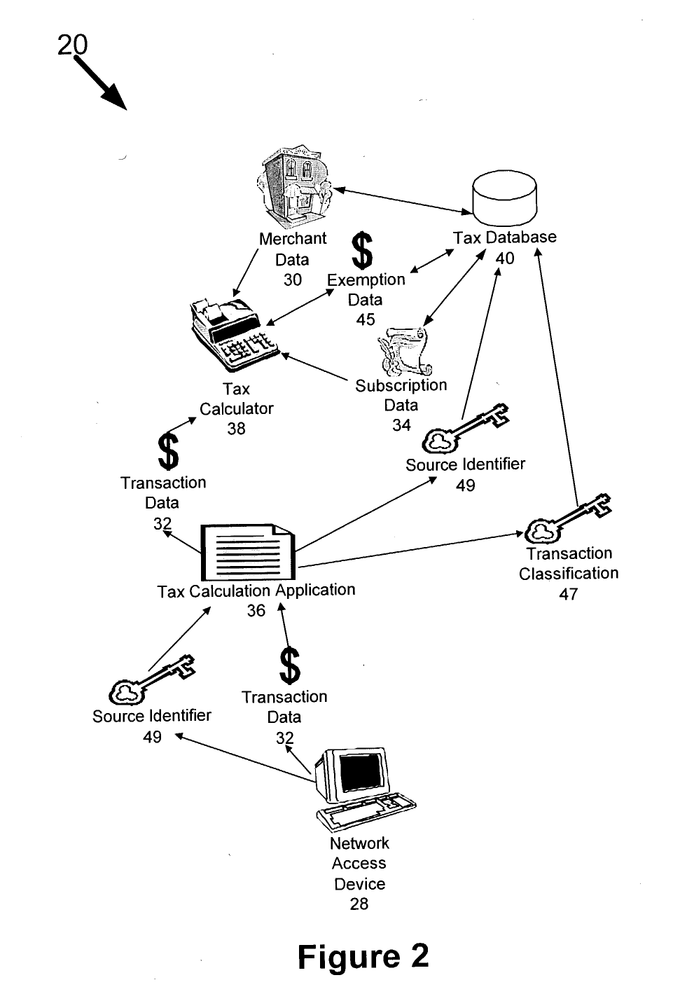

FIG. 2 is a block diagram illustrating one example of ASP embodiment where some of the various information types can be found by the system 20. The access device 28 is the source of the transaction data 32 and a source identifier 49. As discussed above, the access device 28 for transaction data 32 and the source identifier 49 can a shopping cart on the website of the merchant 26. The source identifier 49 can be identifier the merchant 26, or a subgroup of the merchant 26, such as a subsidiary or office location. In some embodiments, the source identifier 49 relates to the subscription. A single merchant 26 can have multiple subscriptions and multiple locations. Similarly, several merchants 26 can potentially share the same subscription and the same location.

As discussed above, the transaction data 32 is received by the application 36, and forwarded on the tax calculator 38. However, transaction taxes 48 can depend on the type or nature of the transaction. Orange juice may be taxed differently from oranges, and foods may be taxed differently than other goods, while services may be taxed differently than goods. Tax authorities 46 typically create complex and often arbitrary distinctions between various types of transactions that should be incorporated into the ways in which the system 20 generates tax calculations 44. The application 36 can identify a transaction classification 47 from the transaction data 34. The transaction classification 47 and the source identifier 49 can be forwarded on to the database 40 so that relevant merchant data 30, exemption data 45, and subscription data 34 can be sent to the tax calculator 38 in addition to the transaction data 32 that was received by the application 36. By storing reusable information on the database 40, the input required from the access device 28 is minimized, and the computational requirements of the access device 28 are also minimized. In an ASP embodiment, the ability to capture, store, and maintain the complexities of tax calculation 44 remotely from the merchant 26 and the access device 28 allows costs to by minimized and distributed across multiple merchants 26 accessing the system 20. The cost of the system 20 per transaction can thus re reduced.

### III. SUBSYSTEM VIEW

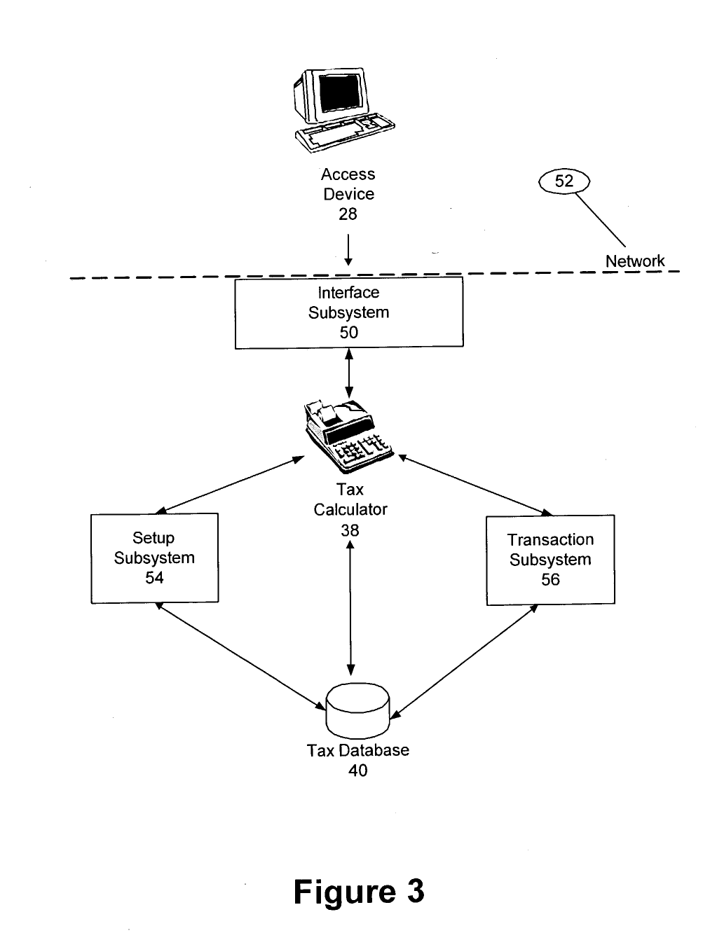

FIG. 3 is a block diagram illustrating one example of a subsystem-view of the system 20. The system 20 disclosed in FIG. 3 includes a network 52. With the exception of an access device 28 residing on the client side of the network 52, all other components are included in the server or ASP side of the network 52.

A. Interface Subsystem

The access device 28 communicates with an interface subsystem 50 on the server side of the network 52. The interface subsystem 50 can be responsible for capturing relevant information from the merchant 26, the purchaser 22, relevant tax authorities 46, and other sources.

The interface subsystem 50 can be divided into a transaction interface for receiving transaction data 32, a subscription interface for receiving subscription data 34, and a merchant interface for receiving merchant data 30. In ASP embodiments, a signup interface (which can also be referred to as a subscription interface) can be used to capture data that is not limited to a particular transaction.

B. Transaction Subsystem

A transaction subsystem 56 can be responsible for processing and accessing transaction characteristics 32 discussed above. The transaction subsystem 56 is responsible for processing information that is limited in scope to the particular transaction between the particular purchaser 22 and the particular merchant 26 for the particular purchased item(s) 24. The only limits to the number of transactions that can be processed by the transaction subsystem 56 are the inherent limits to the infrastructure configuration utilized by the system 20. The transaction subsystem 56 can be configured to receive transaction characteristics 30 from a variety of different sources, including an online shopping cart on a merchant's website. As discussed above, transaction characteristics 32 can include a cost, a location, a classification, a currency, a purchaser, and any other potentially relevant characteristic. Five digit zip codes and nine digit zip codes can be generated by the system 20 from the location characteristic. A wide variety of cost information can be included as transaction characteristics 32, including shipping costs, service charges, and other charges to the purchaser 22. The transaction subsystem 56 can be configured to receive transaction characteristics 32 from an online shopping cart. For example, certain types of purchased items 24 can be exempt on the basis of a category or classification relating to the purchased item 24. The transaction subsystem 56 can automatically identify potential exemptions relating to a particular transaction in a particular jurisdiction based on the data transmitted from the merchant 26 to the tax calculation application 36. This can be done along with the transmission of other transaction data, or it can be done in the setup process of the system 100. Some embodiments of the system 20 may pass along non-transaction data to the tax calculation application 36 along with the transmission of transaction data to setup and configure the system 20. In other embodiments, the system 20 will rely more heavily on a setup subsystem 54 to configure and customize non-transaction characteristics and the data transmitted at the time of the transaction can be limited to a minimum number of transaction data fields.

C. Setup Subsystem

A setup subsystem 54 can be responsible for processing and accessing information required by the tax calculator 38 that is not limited to the specific transaction. Merchant data 30 and subscription data 34 are examples of data that can be processed, updated, and maintained from the setup system 54. Because merchant characteristics 30 are typically an important aspect of the setup process, the setup subsystem 54 can also be referred to as a merchant subsystem in some embodiments. In ASP embodiments where the system 20 is provided to multiple merchants by an ASP, the setup subsystem 54 can also be referred to as a subscription subsystem or a signup subsystem because the characteristics of the subscribing merchant do not typically change with each transaction.

The setup subsystem 54 can be the mechanism by which subscription contracts are executed between merchants 26 and the ASP. In some embodiments, the contract between the merchant 26 and the ASP is a click-wrap license (e.g. click license) that provides for a per transaction charge. A click license is a contract that is executed online, with the merchant 26 indicating their assent to the terms of the contract by clicking an “I agree” button. In such embodiments, if the merchant 26 does not agree, they can be prohibited from utilizing the services of the ASP. The setup subsystem 54 can define the various fees charged by the ASP, including a per transaction charge, a flat fee charge, and other charges.

Exemptions can relate to particular entities, such as purchasers 22 and merchants 26, and thus the setup subsystem 54 can be used to receive, modify, apply, enforce, and modify exemption information. An exemption module within the setup subsystem 54 can be used to create and enforce a list of exempt customers, as well as a list of classifications relating to exemptions.

The setup subsystem 54 can also provide the means for receiving, storing, updating, selecting, applying, and enforcing the nexus characteristics of the merchant 26. In a preferred embodiment, the merchant 26 uses a nexus module within the setup subsystem 54 to select the jurisdictions in which the merchant 26 has a nexus for tax law purposes. In alternative embodiments, the nexus module itself makes the determination applying the tax rules of the relevant tax authority 46.

The tax database 40 and tax calculator 38 can perform the functions discussed above. In some embodiments, the tax database 40 can be referred to as a data storage subsystem and the tax calculator can be referred to as a calculator subsystem.

In a preferred embodiment, any subsystem in the system 20 can communicate directly with any other subsystem in the system 20. In alternative embodiments, there can be more restrictions on the ability of various subsystems to interact directly with other subsystems.

### IV. ALTERNATIVE SUBSYSTEM VIEW

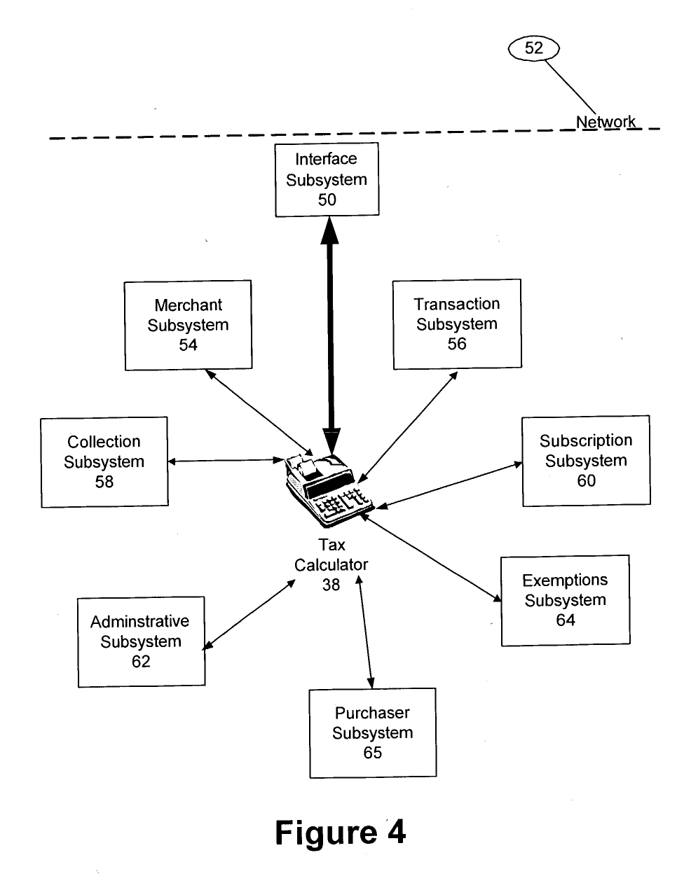

FIG. 4 is a block diagram illustrating another example of a subsystem view of the system 20.

A. Interface Subsystem

The interface subsystem 50 can be responsible for receiving all information relating to merchants 26, subscribers, purchasers 22, purchased items 22, tax rules implemented by tax authorities 46, and any other data, information, or characteristics required by the system 20 to generate a tax calculation 44.

B. Transaction Subsystem

The transaction subsystem 56 can be responsible for all processing relating to transaction data 32. The classification of a purchased item 24 and the price of the purchased item 24 can be important inputs for the tax calculator.

C. Merchant Subsystem

The merchant subsystem 54 can be the means for adding, modifying, applying, deleting, updating, or otherwise accessing merchant characteristics 30.

D. Collection Subsystem

A collection subsystem 58 can be used by the system 20 to automatically collect the transaction 48 tax for a particular transaction without human intervention. The payment of the transaction tax 48 can be received in a wide variety of different forms, including cyber cash, credit card, debit card, wired funds from a bank, or some type of online payment mechanism such as ®PAYPAL.

E. Subscription Subsystem

A subscription subsystem 60 can be used for all processing relating to subscription data 34. The subscription subsystem 60 can be used to configure the way a specific merchant 26 interacts with the system 20.

F. Administrative Subsystem

An administrative subsystem 62 can be used to manage the overall system 20. In an ASP embodiment, the administrative subsystem 62 can be managed by personnel from the ASP. The administrative subsystem 62 can be used to update the licenses subscribers are asked to agree to. The administrative subsystem 62 can also be potentially empowered to modify merchant data 30, subscription data 34, and alter the criteria and tax rules of the system 20.

G. Exemption Subsystem

An exemption subsystem 64 can be used to process exemptions of all types, including exemptions based of product classifications, the identity of the merchant 26, the identity of the purchaser 22, the date in which the transaction takes place, the location of the transaction, or any potential exemption characteristic. In some embodiments, the exemption subsystem 64 can interact directly with taxing authorities 46 to minimize the time between governmental decision making and the implementation of those decisions. The ways in which exemptions can interact with the exemptions of other jurisdictions can also be managed by the exemption subsystem 64.

H. Purchaser Subsystem

A purchaser subsystem 65 can be configured to process, input, update, modify, and delete all information relating to purchasers 22. In some embodiments, some of those functions may be performed by the exemption subsystem 64 or some other subsystem.

### V. WEB SITE DIAGRAMS

A. Home Page

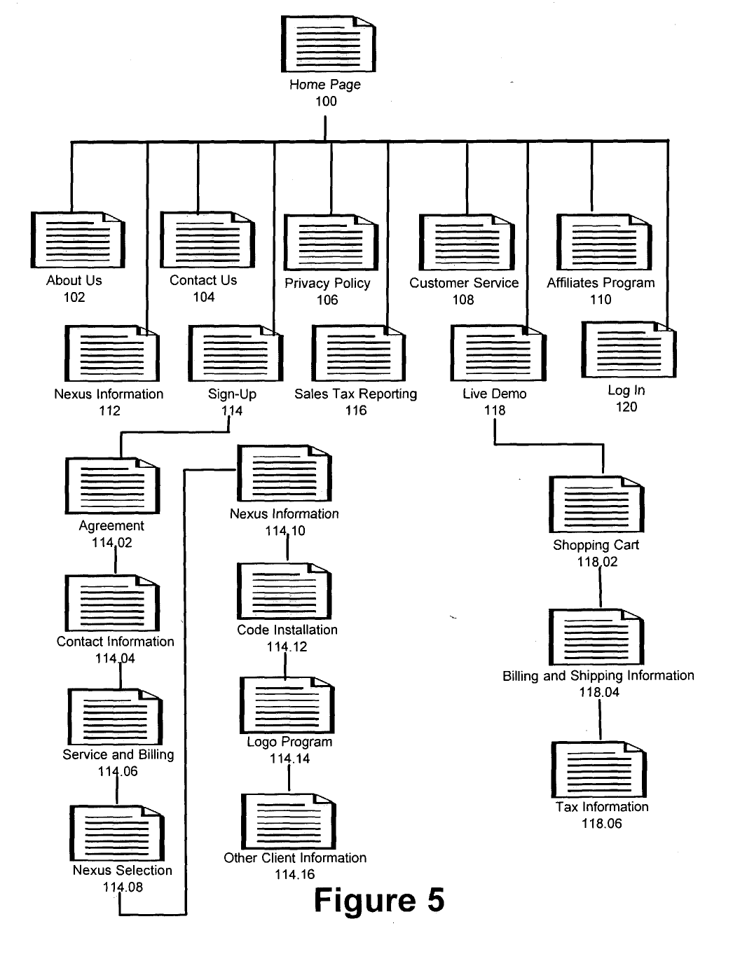

FIG. 5 is a web site diagram illustrating one example of an ASP home page 100. In many embodiments of the system 20, tax calculations 44 are generated at the web site of an ASP after receiving transaction data 32 and a source identifier 49 for obtaining data relating to the merchant 26 or subscriber. In some embodiments, taxing authorities 46 also interact with the system 20. The system 20 can be configured to automatically report all transactions and tax calculations 44 to tax authorities 46 without human intervention. The system 20 can also be configured to automatically collect all transaction taxes 48 and forward those monies to the relevant tax authorities 46.

From the home page 100, customers and potential customers of the ASP (collectively “customers,” “users,” or “subscribers”) accessing the web site can visit the “about us” page 102, where they can learn more about the ASP and the services provided by the ASP. A “contact us” page 104 can be used to initiate subsequent communications between the ASP and its subscribers. A “privacy policy” page 106 provides information to ASP customers and perspective ASP customers of the ASP regarding the privacy policy of the ASP and the web site. The privacy policy can be updated as desired. A “customer service” page 108 can be used by the ASP to describe the customer services provided by the ASP and potentially, various customer service options that can be selected by subscribers. An “affiliates program” page 110 can be used to describe, facilitate, and maintain various business relationships with subscribers. A “nexus information” page 112 can be used to describe current standards for nexus determinations. As tax laws change, the nexus information page 112 can be changed to accurately incorporate those changes. A “sales tax reporting” page 116 can provide information to subscribers regarding reporting requirements from various tax authorities 46. A “log in” page 120 can be used by subscribers and other entities with active accounts with the ASP to actually use the system 20 to generate tax calculations 44.

If an entity is not currently a subscriber and does not have some affiliation with the ASP, subscriber relationships and other relationships, can be created through the use of a “sign up” page 114. An agreement page 114.02 includes a license agreement or contract between the ASP and the user. In some embodiments, the license agreement is a “click-wrap” license (e.g. “click license”) that can be executed by merely clicking on a button signifying acceptance to the terms. Such agreements can include per transaction pricing and/or flat fee pricing. In a click license embodiment, if the user does not agree to the terms, they cannot progress to the “contact information” page 114.04 where the user provides the ASP with contact information for future use.

A “service and billing” page 114.06 can be used by the user to select among service and billing options provided by the ASP. These options can vary dynamically based on the identity of the user, and subscriber characteristics 34 and/or merchant characteristics 30.

A “nexus selection” page 114.08 can be used by merchants 26 to select the jurisdictions in which they have a nexus for tax law purposes. In some embodiments, the system 20 makes the determination(s) itself, based on input provided to the system 20 by the user. A “nexus information” page 114.10 can confirm the selections made by merchants 26 on the prior page. In some embodiments, the system 20 can be configured to automatically perform its own determinations, prompting the merchant 26 to confirm certain nexus determinations.

In some embodiments, some software is loaded on the access device 28 used by the merchant 26. Such software exists on the client side of the ASP network 52, instead of the server side of the network 52. The benefit of such embodiments is the ability to perform tax calculations even if the network 52 is temporarily not functioning or not functioning properly. In some embodiments, the system 20 selectively identifies the types of code and data likely to be required by the particular merchant 26 in order to minimize the amount of code and data stored on the access device 28. The installation of code and data can be performed from a “code installation” page 114.12.

In order to better market the services of the ASP and to provide purchasers 22 with confirmation that their transaction taxes 44 are being calculated in an accurate manner, the ASP can provide a “logo program” page 114.14 to encourage merchants to include the ASP's logo on the merchant's web sites. Additional information can be obtained through an “other client information” page 114.16.

The home page 100 also provides access to a “live demo” page 118. The process of putting items in a shopping cart can be disclosed on a “shopping cart” page 118.02. The process of generating billing and shipping information can be illustrated on a “billing and shipping information” page 118.04. An example of using that information to generate tax information can be provided on a “tax information” page 118.06.

B. Merchant Page

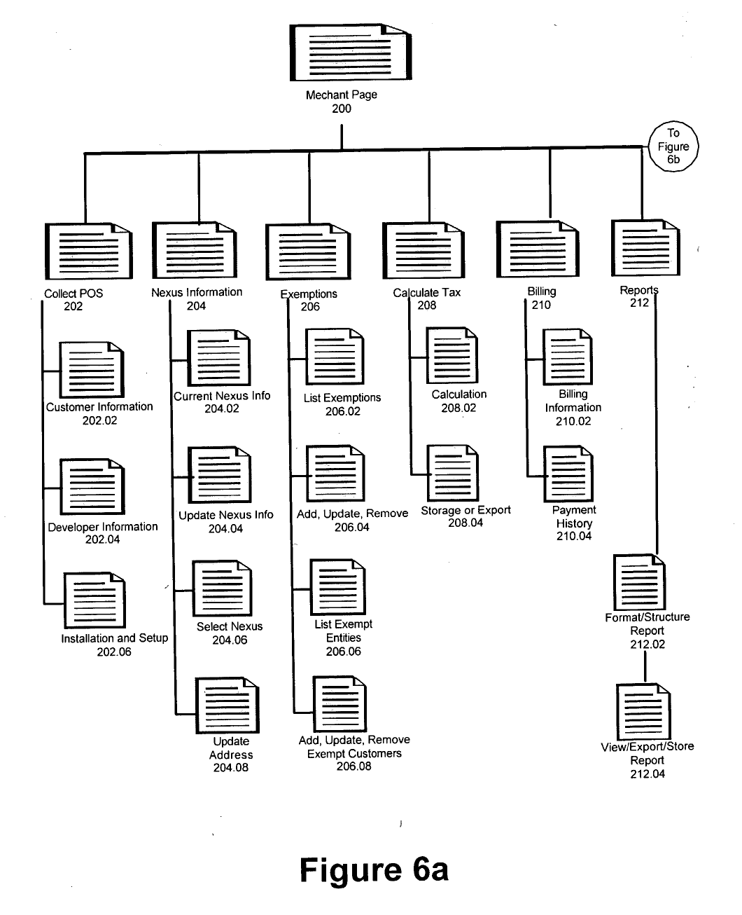

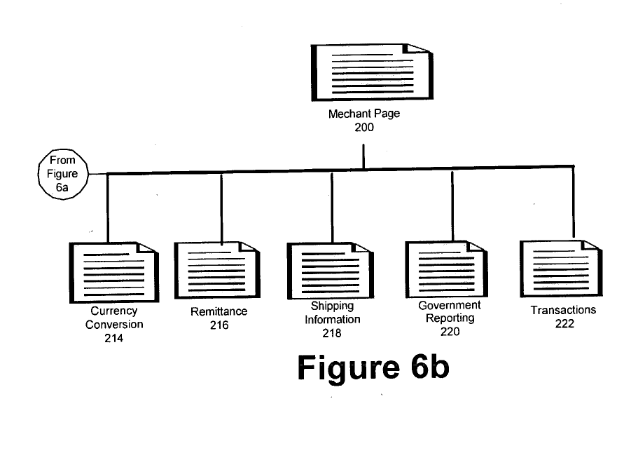

FIGS. 6a and 6b illustrate an example of web page diagram for a merchant page 200. The merchant page 200 provides merchants 26 and potentially other users and/or subscribers the ability to manage their data on the system 20 that is not limited to a particular transaction. Merchant data 30 and subscriber data 34 can be added, updated, and deleted from the various merchant pages 200.

1. Collect POS (User Information and Setup)

A “collect POS” page 202 includes a series of pages for capturing merchant data 30 and subscriber data 34, while configuring the system 20 for use with respect to the particular merchant 26.

A “customer information” page 202.02 can be used to capture merchant data 30 and subscriber data 34. Profile information, functionality preferences, and other data can be captured.

A “developer information” page 202.04 can be used to facilitate technical integration between the merchant's 26 information technology resources and the ASP. For example, the ability to seamlessly send data from an online shopping cart located on the merchant's website to the system 20, certain customized development and/or programming tasks may need to be performed.

An “installation and setup” page 202.06 can be used to configure the system 20 to the specifications and selections of the merchant 26. In some embodiments, software code and data is actually loaded onto the access device 28 of the merchant 26. In such embodiments, the software and data are loaded from the “installation and setup” page 202.06.

2. Nexus (Substantial Presence) Information

A “nexus information” page 204 can be used to input, modify, delete, and maintain nexus information relating to a subscriber, or merchant 26. The “nexus information” page 204 can be described as a nexus module.

Existing nexus information can be viewed from a “current nexus information” page 204.02. Nexus information can be updated from an “update nexus information” page 204.04. In some embodiments, nexus selections are made from a “select nexus” page 204.06 by the merchant 26 actually selecting one or more jurisdictions. In other embodiments, the merchant 26 provides some of the underlying information, and the system 20 makes the nexus determinations itself. Address information can be updated from an “update address” page 204.08.

3. Exemptions

An “exemptions” page 206 can be used by merchants 26 and other users of the system 20 to create, update, delete, and maintain exemption data. The functionality of the “exemptions” page 206 can be referred to as an exemptions module.

Current exemptions based on product classifications that are relevant to the merchant 26 can be viewed on a “list of exemptions” page 206.02. Exemptions can be added, updated, or removed from an “add, update, remove” page 206.04. Exemptions can also relate to the identity of the purchaser 22. A list of existing exempt customers can be viewed from a “list of exempt customers” page 206.06. Customer-based exemptions can be added, updated, or removed from an “add, update, remove exempt customers” page 206.08. As discussed above, exemption information can be passed along at the time of the transaction, or in the setting up of the system 100.

4. Calculate Tax

A “calculate tax” page 208 can be used to configure the tax rules for a particular merchant 26 or subscriber. A “calculation page” 208.02 can be used to perform calculations 44 for a particular transaction in a manual or automated manner. A “storage or export” page 208.04 can be used to configure the way in which tax calculations 44 are stored or exported for a particular merchant 26 or subscriber.

5. Billing

A “billing” page 210 provides the subscriber or merchant 26 with financial data relating to the relationship of the subscriber or merchant 26 with the ASP. Currently billing information can be provided through a “billing information” page 210.02. Past payment history can be viewed through a “payment history” page 210.04. Information relating to per-transaction charges and flat-fee subscription charges can be viewed from the various “billing” pages 210.

6. Reports

A “reports” page 212 can be used to invoke template report formats, create new report templates, and create ad hoc reports for use by the ASP or for use by the merchant 26. A “format/structure report” page 212.02 can be used to format ad hoc and reusable template reports. A “view/export/store report” page 212.04 can be used to generate reports with configure the ways in which data is stored and/or exported.

7. Currency Conversion

The website diagram continues in FIG. 6b. A “currency conversion” page 214 provides merchants 26 with the ability to automatically perform currency conversion functionality in a real-time (instantaneous or substantially instantaneous manner). This functionality can be achieved by linking the transaction server of the ASP to third party servers. Alternatively, the transaction server for the system 20 could import the requisite data on a continuous basis. The merchant 26 can configure its use of the system 20 so that the currency conversion process is transparent to the purchaser 22.

8. Remittance

A “remittance” page 216 can be used to facilitate the tax 48 collection and payment by the merchant 26 to the taxing authority 46 in an automated and real-time manner. This functionality can be configured to occur with each transaction, or the system 20 can be configured to transmit the tax 48 payment on an hourly, daily, weekly, monthly, or some other basis. In some embodiments of the system 20, each merchant 26 is free to determine the appropriate frequency and timing of tax 48 payments.

9. Shipping Information

A “shipping information” page 218 can be used to provide real-time shipment tracking information. The information can be imported to the system 20 from servers managed by Federal Express, UPS, the U.S. Postal Service, etc.

10. Government Reporting

A “government reporting” page 220 can be used to configure and automate the process of reporting transaction and transaction tax data to the appropriate tax authorities 46. This can preferably be done electronically, by interacting with a server managed or controlled by the appropriate tax authority 46. In other embodiments, this functionality can be used to automate the creation of “hard copy” (e.g. paper) reports that are automatically mailed to the appropriate tax authorities 46. In some embodiments, the merchant 26 may contract with the ASP for the ASP to take responsibility for interactions with the tax authorities 46.

11. Transactions

A “transactions” page 222 allows the merchant 26 to configure the archiving functionality of the system 20. In a preferred embodiment of the system 20, merchants 26 will desire the ability to audit, and otherwise process or review past transactional data. The archives should preferably include various tax schedules as well as the underlying transactional data in support of those tax schedules.

C. Administrator Page

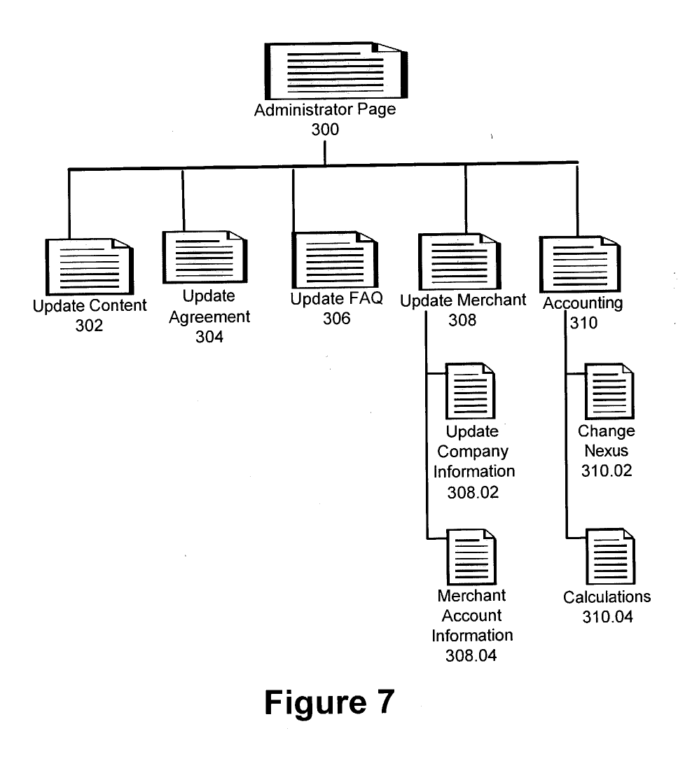

FIG. 7 is a web page diagram illustrating an example of an administrator page 300. The administrator page 300 can be used personnel from the ASP, and in some embodiments, the merchant 26, to add, modify, and delete functionality from the system 20.

An “update content” page 302 can be used to add, update, or remove content from the website. An “update agreement” page 304 can be used to make changes to the click license described above. An “update FAQ” page 306 can be used to add, update, and delete text from a frequently asked questions page.

An “update merchant” page 308 can be used by a third party such as an ASP to update merchant data 30. Company information can be updated on an “update company information” page 308.02. Information relating to the merchant's 26 account with the ASP (e.g. subscription data 34), can be accessed from a “merchant account information” page 308.04.

An “accounting” page 310 can be used to access a “change nexus” page 310.02 and a “calculations” page 310.04. The pages can be used to manage the accounting and tax rules applied by the system 20. The system 20 is highly adaptable, and can be configured to implement merchant-based customizations.

### VI. PROCESS-FLOW VIEWS

The system 20 is highly flexible, and it can incorporate many different embodiments involving many different process variations. Some system 20 processes are dependent on the particular tax law provisions relating to the transaction. For example, in the United States, interstate transactions are preferably calculated as destination-based transactions. Tax calculations can also be dependent upon how the system 20 is configured. In some embodiments, a sale in a state where the destination is not matched to a state where the system 20 is instructed to collect a tax will result in no tax being collected. In order to correctly calculate certain taxes such as a maximum tax, it is desirable to receive a copy of the entire shopping cart.

A. Example 1

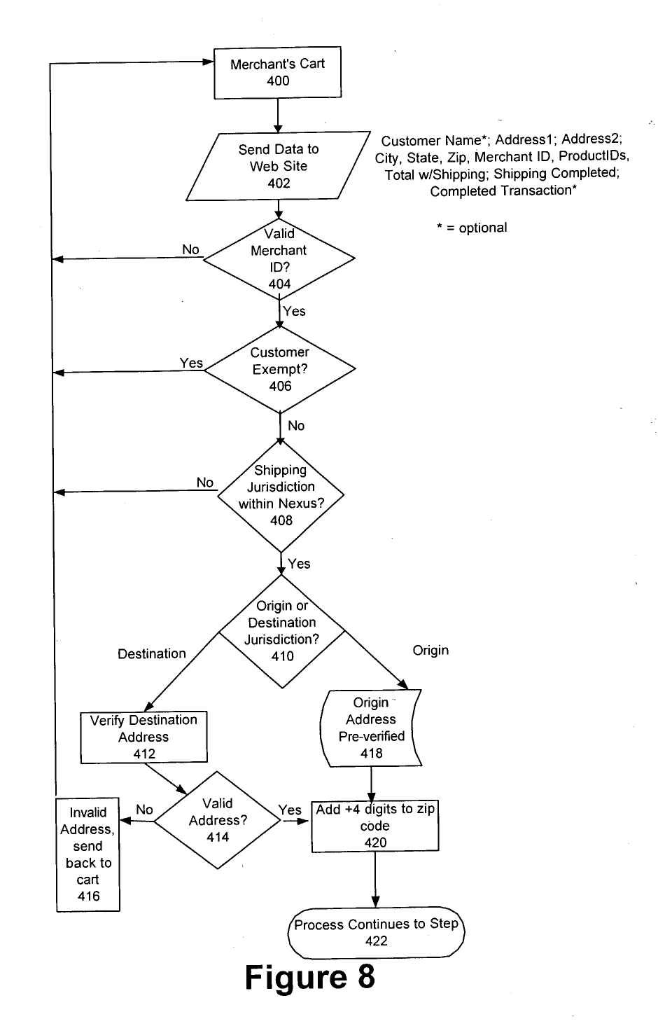

FIG. 8 is a flow chart diagram illustrating an example of a process flow beginning with the sending of data from a merchant's cart at 400 and ending with the transformation of a 5 digit zip code to a 9 digit zip code at 420.

A merchant's cart at 400 is located on the web site of the merchant 26. The cart can capture a wide variety of different information. At 402, certain data is sent to the ASP web site. In many embodiments, the data sent will include a: customer name, address information, merchant ID, product ID(s) relating to the particular transaction, total cost, shipping cost, and a transaction completed flag. Other embodiments will include a different variety of data and characteristics.

At 404, it is determined whether or not the merchant 26 providing the information is a subscriber or is otherwise listed on the system 20. If the sender is not identifiable by the system 20 given the data sent at 402, the process returns to the shopping cart at 400. If the sender is listed at 404, the process continues to 406 to determine whether or not the customer is exempt. If the customer is exempt 406, no taxes are due, and the process returns to the cart at 400 with a determination that no taxes are due. If the customer at 406 is not exempt, the process continues to a shipping/nexus comparison at 408.

At 408, if the shipping jurisdiction is not a nexus jurisdiction, then no sales tax are due, and the process returns to the shopping cart at 400 with no sales tax due. In some embodiments, the process continues because use taxes may be due.

At 410, a determination is made by the system 20 whether or not the shipping jurisdiction is a destination jurisdiction or an origin jurisdiction. If the jurisdiction at 410 is a destination jurisdiction, the destination address is verified at 412. If the address at 414 is invalid, the address is identified as invalid, and the process returns to the merchant's cart at 400. If the address is valid at 414, the system 20 references a nine-digit zip code database 42 to generate a nine-digit zip code for the shipping destination at 420.

If the system 20 at 410 determines that the jurisdiction is an origin jurisdiction, the origin address is pre-verified at 418. In other embodiments, origin address (the merchant's address) can be verified at 418 in the same way that destination addresses are verified at 412. At 420, a nine-digit zip code can be generated from the origin address.

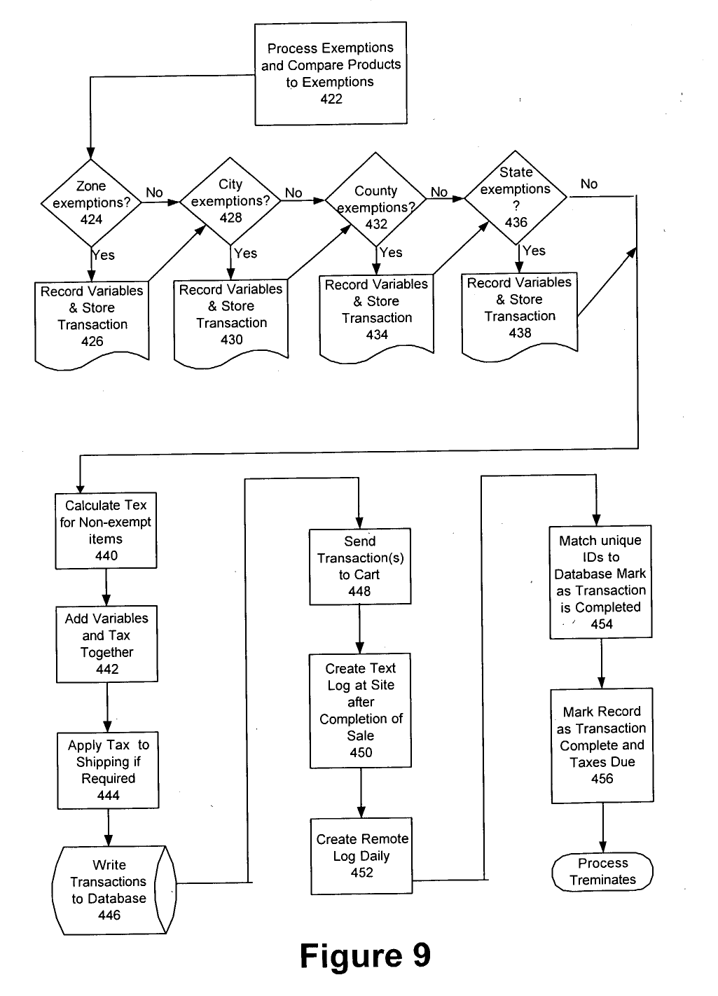

Regardless of whether the jurisdiction is an destination or origin jurisdiction, valid addresses can be used to generate nine-digit zip codes for subsequent processing at 420. The process at 422 continues on FIG. 9.

FIG. 9 discloses an example of a flow chart that continues where FIG. 8 ended. FIG. 9 illustrates an example of system 20 processing from jurisdiction-based exemption processing at 424 through the recording of a transaction at 456.

At 422, product classifications in the purchased items 24 are compared to product-based exemptions at the various jurisdictions which may relate to the transaction. Zones are subsets of cities. A single city can have many different zones or “localities.” If zone exemptions exist at 424, relevant data is stored at 426. If city exemptions exist at 428, relevant variables are stored at 430. If county exemptions exist at 432, relevant variables are stored at 434. If state exemptions exist at 436, relevant variables are stored at 438.

At 440, transaction taxes are calculated for non-exempt items. At 442, all variables and taxes are added together. At 444, taxes are applied to shipping charges, as required by the various jurisdictions. At 446, transactions are written to the tax database 40. At 448, the transaction information can then be sent back to the shopping cart on the merchant's 26 web site. At 450, a text log can be created at the web site after completion of the sale. At 452, a remote daily log can be created at the merchant's site for the convenience of the merchant 26. Logs can also be created for purchasers 22 and tax authorities 46.

At 454, unique Ids are matched to the database as a transaction is executed by the purchaser 22 and merchant 26. All relevant records at 456 are marked as completed, with tax being due. In some embodiments, a report is sent at 456 to the various tax authorities. In some embodiments, the system 20 collects the transaction tax 44 itself and forwards that payment to the tax authority 46.

B. Example 2

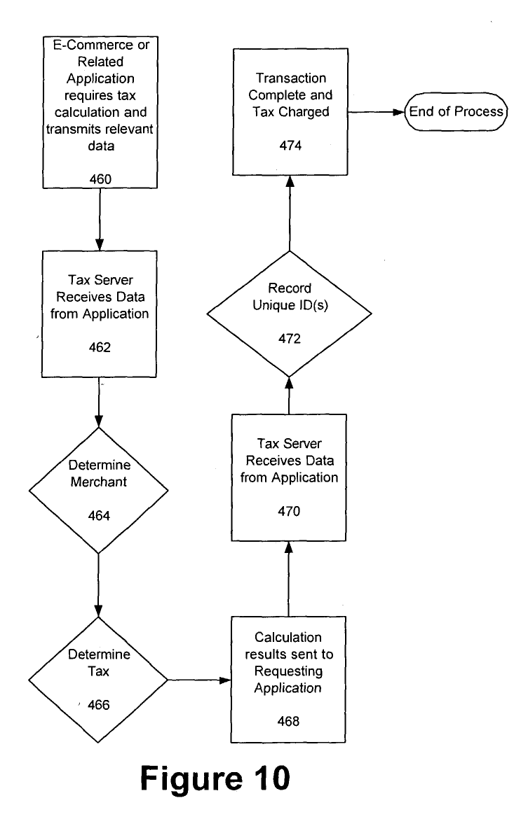

FIG. 10 is an example of a flow chart describing a process from an e-commerce transaction at 460 through the completion of a transaction with tax charges at 474.

At 460, an e-commerce or related application that requires a potential tax calculation 44 requests a tax calculation 44 from the system 20. At 462, the network server of the ASP receives relevant transaction data 32 and at least one source identifier 49. At 464, the system 20 determines the identity of the merchant 26 and relevant merchant characteristics 30 from the source identifier 49.

At 466, the system 20 generates a tax calculation 44 using the tax calculator 38. At 468, the tax calculation 44 is sent to the requesting merchant 26 web site or application. At 470, the network server for the ASP receives data from the merchant's 26 web site or application, confirming the execution of the transaction. At 472, all unique IDs such as merchant ID, subscription ID, product ID, and other identifiers are captured by the system 20 and recorded in the tax database 40. At 474, the transaction is completed with transaction charges being identified as due.

C. Example 3

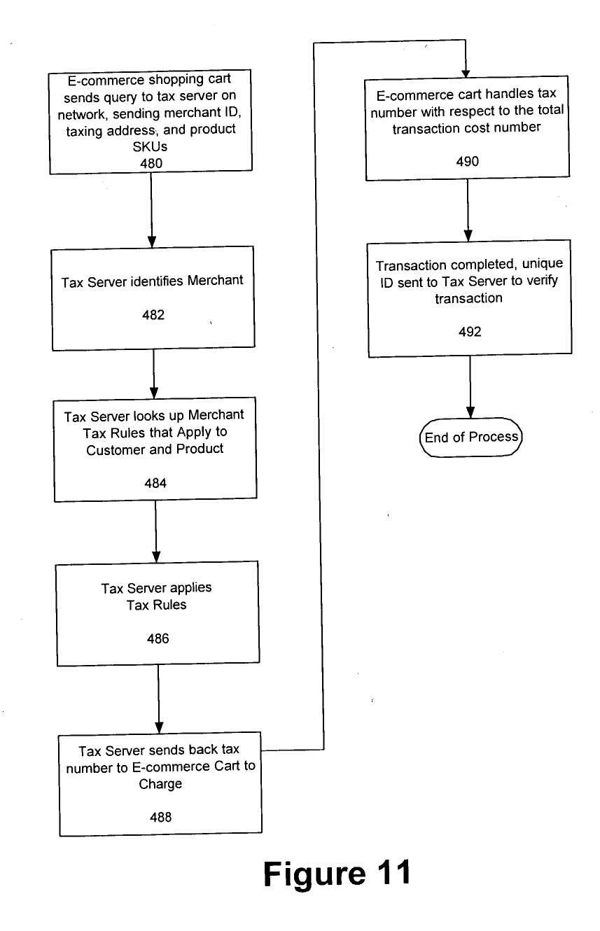

FIG. 11 is a flow chart illustrating a second example of a process flow beginning with the tax calculation 44 request at 480 of an ecommerce shopping cart from a merchant 26 web site to the finalizing of a transaction at 492.

At 480, an e-commerce shopping cart can send transaction data 32 including product classifications relating to purchased items 24 and potential product exemptions, to the system 20. One or more source identifiers 49 can also be sent.

At 482, the system can identify the merchant 26 through the use of the source identifier 49.

At 484, the system 20 can look up the tax rules for the particular merchant 26, as entered through the “merchant” page 200.

At 486, the system 20 can apply the tax rules configured for the particular merchant 26, to the transaction involving the particular merchant 26.

At 488, the system 20 can send back the tax calculation 44 to the e-commerce cart so that the transaction tax 48 can be included in the requirement payment 25 to the merchant.

At 490, the e-commerce cart can list the total payment 25 required for completion of the transaction.

At 492 the transaction is completed, with all relevant unique IDs and other data being stored on the tax database 40.

D. Example 4

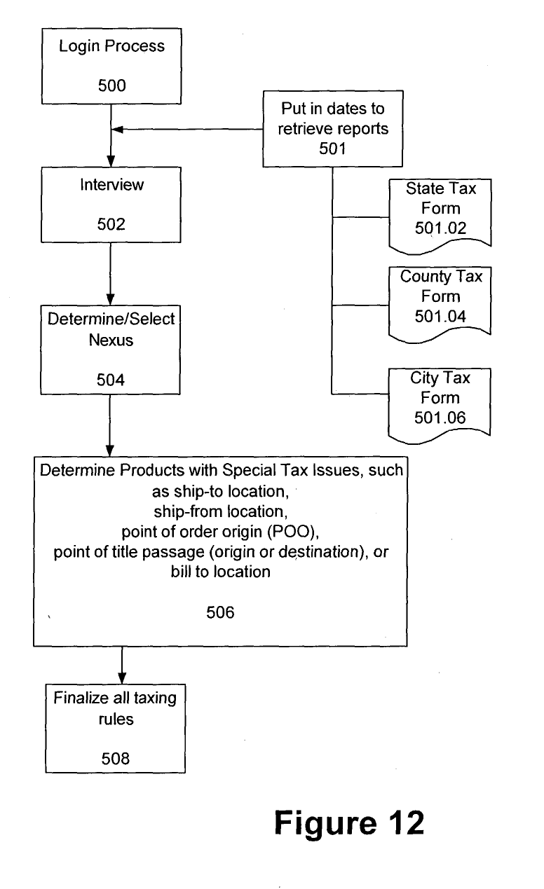

FIG. 12 is a flow chart illustrating one example of a setup process for a merchant 26 or other forms of subscribers. A log-in process is performed at 500. At 501, dates are inserted into pre-determined tax forms such as a state tax form at 501.02, a county tax form at 501.04, a state tax form at 501.06, and any other tax forms for relevant tax authorities 46.

An interview is conducted at 502. In many embodiments, this is an automated exchange between the merchant 26 and predetermined business rules in the system 20. In other embodiments, a human being acts on behalf of the ASP.

Nexus jurisdictions are determined at 504. In many embodiments, the merchant 26 makes nexus selections. In other embodiments, the system 20 applies legal judgments to facts supplied by the merchant 26.

At 506, the system 20 can identify purchased items 24 with special tax issues such as a ship-to location, a ship-from location, a point or order origin (POO), a point of title passage (origin or destination), or a bill to bill location. All taxing rules can be finalized at 508.

E. Example 5

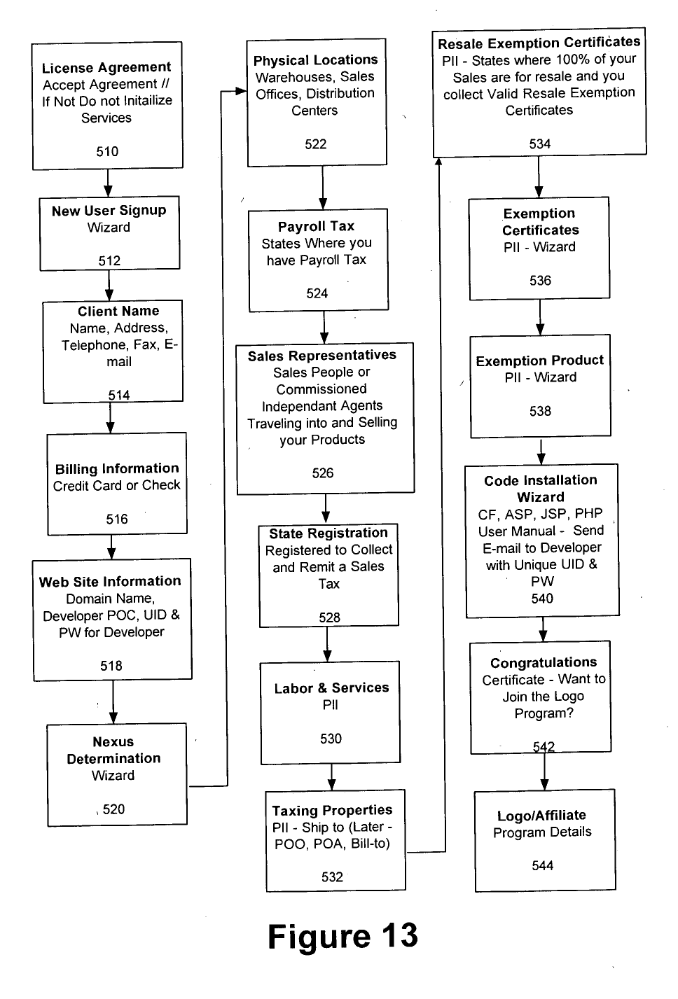

FIG. 13 is a flowchart illustrating an example of a process in an ASP embodiment of the system 20 beginning with the review of a license agreement at 510 through the installation process at 540 through joining a logo/affiliate program at 544.

At 510, the potential subscriber reviews the license agreement. If the agreement is not accepted by the merchant 26 or subscriber, then no tax calculation services should be provided by the system 20.

At 512, the new user signup wizard is invoked to walk new subscriber through the sign-up process. Merchant data 30 is entered at 514. Billing information such as credit card or check data and other subscription data 34 can be entered at 516.

Web site information such as domain name and developer information can be provided at 518. This information allows online carts on the merchant page 200 to communicate in a transparent manner with the system 20.

A nexus determination wizard can be invoked at 520. In many embodiments, the actual determination is left to the legal judgment of the subscriber. In other embodiments, the system 20 supplies the legal judgment to facts made known to the system 20.

Information relating to the location and functions of physical locations can be entered at 522. Physical locations can include warehouses, sales offices, distribution centers, and other location types.

Payroll tax information can be supplied at 524. In a preferred embodiment, the merchant 26 identifies the jurisdictions in which payroll tax is paid by the merchant 26.

Sales representative information can be entered at 526. Employees as well as commissioned and independent agents can be inputted into the system 20. Traveling profiles and location information can also be included.

State registration information can be received by the system 20 at 528. The merchant 26 can identify states in which sales taxes are collected and remitted.

A labor and services determination at 530 can allow the merchant 26 to collect exemption certificates based on the labor and/or services provided by the merchant 26.

Taxing properties at 532 relating to characteristics such as ship to, ship from, POO (e.g. POS), POA (e.g. POD), and Bill-to, can be entered into the system 20 by the merchant 26.

At 534, the system 20 can determine whether resale exemption certificates should be issued because 100% of the sales activities in a particular state or other jurisdiction, are solely for resale. Those certificates can be issued at 536. Product-based exemptions based on product classifications can be identified by the system 20 at 538.

In some embodiments, code and data are stored on the access device 28 of the merchant 26 used by the merchant 26 to access the system 20. In some embodiments, code and data used to integrate merchant 26 online carts with the system 20 may require additional code components. Regardless of the purpose of the code and data components, they can be installed through the use of an installation wizard at 540.

A congratulatory message can be sent at 542, along with an invitation to join the logo/affiliates program. Details of such additional programs can be provided at 544.

F. Example 6

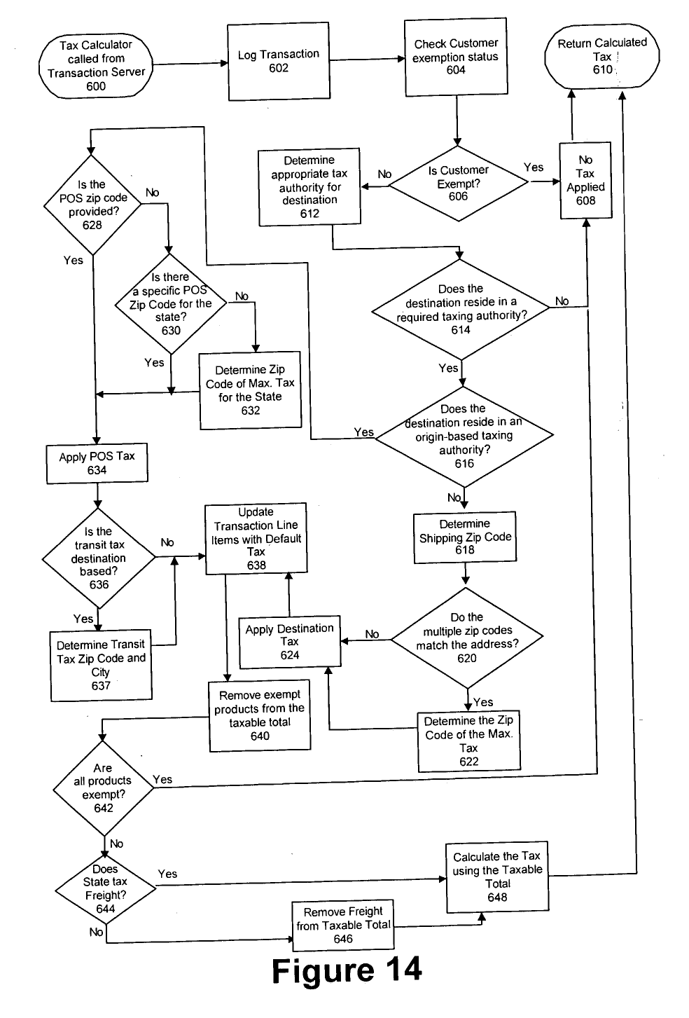

FIG. 14 is a flow chart illustrating one example of a tax calculation process. At 600, merchant data 30, subscription data 34, and transaction data 32 are accessed by the system 20 when the tax calculator 38 is called from the transaction server. In a preferred embodiment, the invocation of the system 20 is made by the merchant 26 access device 28 passing along the variables of merchant ID, POS (“point of sale/service”) zip code, customer name (first and last), shipping address (address 1 and address 2, city, state, and zip), billing address (address 1 and address 2, city, state, and zip), shopping cart (array of product IDs, quantity and amount), total (shipping and product), and shipping.

At 602, the transaction is logged into the system 20 after the transaction server invoking the system 20 is authenticated. The transaction logger can log the information just as is into a transaction tax table and a tax line item table. The time of the transaction can also be logged. Time is preferably logged relative to where the tax 48 is taken. Destination-based tax calculations 44 uses the time zone of the shipping address and origin-based tax calculations 44 use a point of sale/service zip code. Factors such as daylight savings time should be incorporated into all calculations as appropriate to preserve the accuracy of the information. Enough information should be logged so that a transaction can be recreated without the use of the primary database tables in the system 20.

If the information provided by the transaction server resulted in some type of flow error, the system 20 can default to a, destination-based tax heuristic. The log can document transactions in which default rules were applied. The log can also be used to automatically generate daily e-mail alerts to merchants 26. Those e-mails can include summaries of any issues that arose during a particular period of time. Potential errors such as wrong or unregistered POS, multiple zip codes for a particular address, etc. can then be dealt with by the merchant 26. In preferred embodiments, merchants 26 can customize the manner in which their logs are stored, and thus merchants 26 can customize the ways in which errors or even potential errors are processed.

At 604, the merchant's 26 exemption status is checked. This process can look up the customer in a merchant's exempt customer list using the billing address. This process can also make sure that the customer's exemption is not limited to a particular product.

If the customer is exempt at 604, then no tax is to be applied at 608 and the amount of zero is returned as the calculated tax at 610.

If the customer is not exempt at 604, the system 20 determines the appropriate tax authority of the shipping destination at 612. The system 20 can search for tax records on the basis of a nine digit zip code, a five digit zip code, a city name, or some combination of variables. However, at 612, the system 20 is not searching specifically against a zip code or address, but rather the state code for the shipping state., If a merchant 26 passes the system 20 a wrong zip code, the error can be caught at 616. The system 20 links to a merchant information on the system 20 database to determine if the destination state has been flagged as having a (e.g. “point of sale/service” in a origin-based tax jurisdiction). If not, then a typical origin-based jurisdiction is flagged as a destination-based jurisdiction (“point of destination” or “POD” jurisdiction). If the destination state has a POS, then subsequent validation can determine whether or not the provided POS zip code is a registered merchant POS in the provided shipping address state and whether or not there is only one fixed POS for the merchant 26 in any state. If the provided POS is not valid or if the merchant 26 has more than one fixed POS then the transaction is marked as a destination-based sale and an alert can be raised in accordance with the business rules established by the merchant 26. A merchant 26 with more than one POS must provide a valid POS zip code with each transaction, or the system 20 will default to a destination-based calculation heuristic. The corresponding freight charge can be automatically calculated by the system 20 is the merchant 26 is applying a standard rate already stored on the system 20. As with all calculations, the system 20 can be configured to receive overrides of default rules as part of the transaction data received by the transaction server.

At 614, the system 20 determines whether the destination for the transaction resides in an origin-based tax jurisdiction. This done by searching for the appropriate tax authority 46 using a tax authority database table. In some embodiments, these determinations are entered by the merchant 26 in implementing the system 20. In other embodiments, the ASP organization can make itself responsible for applying tax expertise.

If the destination does not reside in a required tax authority 46, no tax is applied at 608 and a tax value of zero is returned at 610. If the destination does reside in a required tax authority 46, the system 20 then determines at 616 whether the destination resides in an origin-based tax authority 46.

If the transaction destination does reside in an origin-based tax jurisdiction at 616, the system 20 then determines at 628 whether or not the POS zip code or other form of POS zone identifier is provided in the transaction data provided to the system 20. If no POS zone identifier is provided at 616, the system 20 determines at 630 whether or not there is a specific POS zone identifier for the state. If no such zone identifier exists, then the system 20 determines the zone identifier that would result in the maximum tax 48 for the particular jurisdiction (e.g. state).

At 634, the POS tax is applied using the POS zone identifier. At 634, the system 20 determines whether the transit tax for the particular transaction is destination based. If the transit tax is destination based, the system 20 obtains the transit tax zone identifier and city at 637. Otherwise, the transaction line items are updated with default values at 638. In some embodiments, a nine digit zone identifier such as a nine digit zip code is used by the system 20 to obtain the appropriate tax rates. City information may also be required by the system 20. If transit is collected at the destination, then the nine digit zone identifier (e.g. shipping nine digit zip code) is processed by the system 20. The time zone of the merchant 26 and the shipping city should also be incorporated into the calculations as appropriate.

In either case, the system 20 at 640 removes exempt products and services from the taxable total. The system 20 does this by looking at the various jurisdiction exemption tables discussed below. Those exemption tables use identifiers such as the nine digit zone identifier to update the tax transaction line items with the correct tax omissions and exemptions. This does not remove any potential freight charges from the exempt products.

At 642, the system 20 determines whether or not all products (e.g. purchased items 24) in the transaction shopping cart are exempt. If each product at 642 is exempt, then no tax is applied at 608 and a tax value of zero is returned at 610. If at least one product is not exempt, then the system 20 determines at 644 whether the tax authority 46 (e.g. state government in the U.S.) taxes freight. If freight is not to be taxed, then the value of freight should be removed from the taxable total at 646. Regardless of whether freight is taxable, the system 20 calculates the tax using the total taxable value at 648. The results of the tax calculation 44 can then be returned as the calculated tax 610 that is sent back to the transaction server of the merchant 26.

If the transaction destination does not reside in an origin-based taxing jurisdiction at step 616, the system 20 then determines the shipping zip code (e.g. zone identifier) at 618 This can be done by calling an external web service to validate the address and translate a five digit zip code to a nine digit zip code. In other embodiments, this can be done internally by the system 20. At 620, the system 20 determines whether or not multiple zone identifiers match the destination address. If multiple matches exist at 622, then the system 20 identifies the maximum tax among the multiple matching tax authorities 46. At 624, the system 20 applies the destination tax. The process then continues to the updating of the transaction line items at 636 as described above.

### VII DATA-DESIGN VIEWS

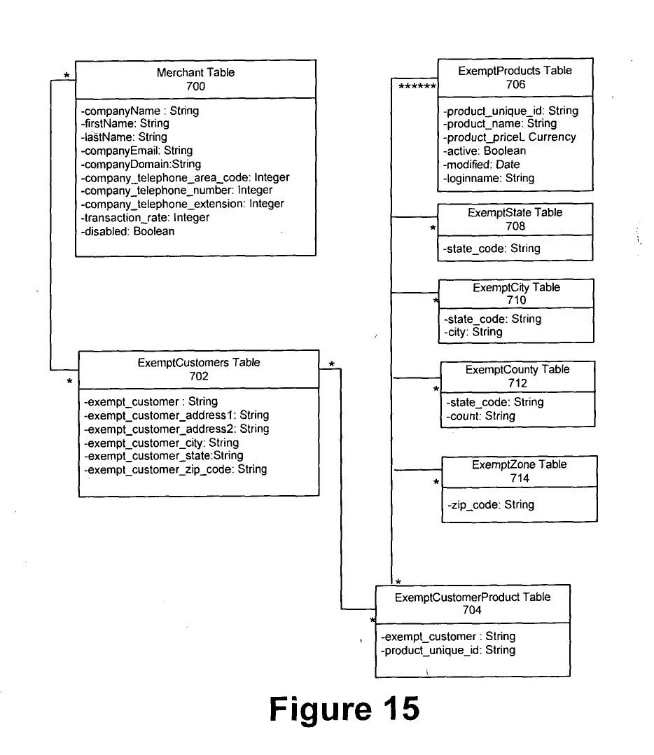

FIG. 15 is a database diagram illustrating one example of how exemption information can be stored.

A. Exemption Information

1. Merchant Table

A merchant table 700 is used to store information relating to a particular merchant 26, such as the transaction rate the merchant 26 is charged as a customer of an ASP in an ASP embodiment of the system 20. In some embodiments, a single corporation can include different merchants 26. For example, there could be subsidiaries (both domestic and foreign) that require distinct representation in the merchant table 700.

2. Exempt Customers Table

An exempt customers table 702 stores exemption information relating to the customers of the merchant(s) 26 represented in the merchant table 700. A particular customer may be exempt in particular jurisdictions and not other jurisdictions, and the exemptions can be limited to particular products and not other products.

In a preferred embodiment, the exempt customers table 702 has a many-to-many relationship with the merchant table 700 and an exempt customer products table 704.

3. Exempt Customer Product Table

The exempt customer product table 704 is the bridge between the exempt customers table 702 and an exempt products table 706. The exempt customer product table 704 has a many-to-many relationship with the exempt products table 706 because multiple customers can buy the same product (e.g. purchased item 24).

4. Exempt Products Table

The exempt products table 706 stores a list of products (e.g. purchased items 24) that are potentially exempt in at least one jurisdiction relevant to the system 20. Exemption determinations are ultimately a jurisdiction-specific inquiry. Thus, the exempt products table has a many-to-many relationship with each of the jurisdiction exemption tables.

5. Jurisdiction Exemption Tables

The number of jurisdiction exemption tables can vary from embodiment to embodiment. In some embodiments, all jurisdiction-based exemption information can be combined into a single database table.

An exempt state table 708 can be joined with the exempt customer product table 704 to identify specific customer products that are exempt from transaction taxes with respect to the state. An exempt city table 710 can be joined with the exempt customer product table 704 to identify specific customer products that are exempt from transaction taxes with respect to the city. An exempt county table 712 can be joined with the exempt customer product table 704 to identify specific customer products that are exempt from transaction taxes with respect to a particular county. An exempt zone table 714 can be joined with the exempt customer product table 704 to identify specific customer products that are exempt from transaction taxes with respect to a particular zone, such as an area sharing the same zip code.

B. Address/Jurisdiction Information

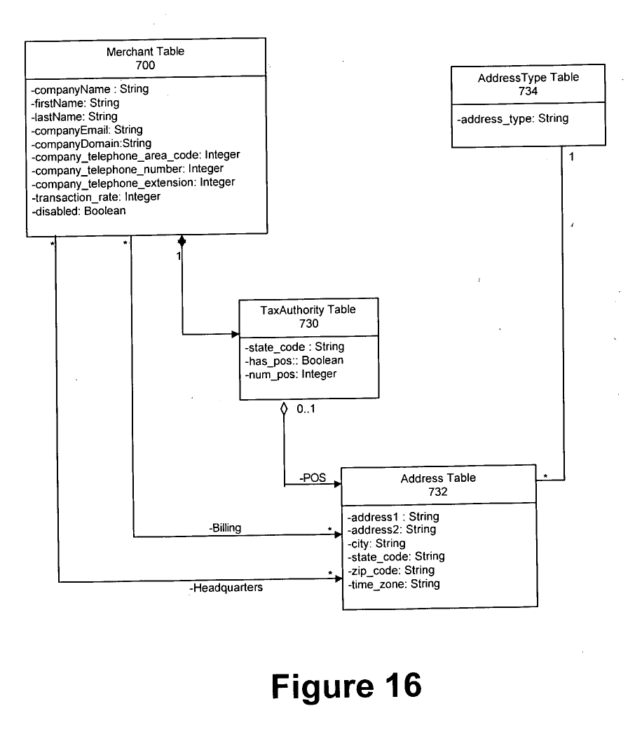

FIG. 16 is a database diagram illustrating one example of how information relating to merchants, addresses, and tax authorities can be stored.

1. Merchant Table

A merchant table 700 is used to store information relating to various merchants 26. In an ASP embodiment of the system 20 where merchants 26 are the customers of the ASP, the merchant table 700 is likely to be heavily populated. In non-ASP embodiments where a single corporation uses the system 20, there may be more than a single listing in the merchant table 700 because an individual merchant 26 may have multiple subsidiaries or other internal groups that merit distinctions in the merchant table 700.

2. Address Table

An address table 732 is used to store all of the addresses relevant to tax computations by the system 201. In embodiments of the system 20 that involve an ASP supporting multiple merchants 26 and the storage of all transactional information after the transaction tax 48 is calculated, the address table 732 may be the most heavily populated table in the system 20. In such an embodiment, each individual shipping destination is stored for audit purposes, even if there is no reason to suspect that a particular address will ever be used again by the system 20.

In a preferred ASP embodiment of the system 20, there is a single merchant 26 listed on the merchant table 700 can have many addresses on the address table 732. For example, a single organization can have different addresses for billing, headquarters, shipping/receiving, etc.

3. Address Type Table

An address type table 734 is used to store categories of addresses. Each address type is listed only once on the address type table, but numerous rows of data in the address table 732 might be of the same address type. For example, each company is likely to have at least one billing address, but there is only one “billing address” in the address type table 734. By categorizing address types, the system 20 can support automated transaction tax 48 calculations. The address type table 734 helps reflect how the various tax jurisdictions classify transactions on the basis of locations and types of locations.

4. Tax Authority Table

A tax authority table 730 is used to store data representing the various tax jurisdictions. If the embodiment of the system 20 includes a hierarchy of jurisdictions that is four levels deep (e.g. state, county, city, and zone), then the various rows of the tax authority table 730 will include particular states, counties, cities, and zones. Other embodiments may involve different jurisdictional geographies and/or hierarchies. For example, nations could be included in the tax authority table 730, in addition to the various subunits of a nation. Different nations will involve different jurisdictional hierarchies and geographies, but the system 20 can be configured to support such variations.

Each tax authority 46 in the tax authority table 730 can relate to multiple addresses (e.g. points of service) in the address table 732. The point of service Boolean variable in the tax authority table 732 indicates whether or not a particular jurisdiction is a point of service jurisdiction (e.g. destination-based transaction tax). Each merchant 26 in the merchant table 700 can do potentially do business in each tax authority 46 represented in the tax authority table 46.

### VIII. ALTERNATIVE EMBODIMENTS

In accordance with the provisions of the patent statutes, the principles and modes of operation of this invention have been explained and illustrated in preferred embodiments. However, it must be understood that this invention may be practiced otherwise than is specifically explained and illustrated without departing from its spirit or scope.

In the claims:

1. A tax calculation system, comprising:
a transaction server, including a purchase interface;
a tax server; and
a network connection between said transaction server and said tax server;
wherein said purchaser interface is configured to initiate a transaction, said transaction including a plurality of transaction characteristics;
wherein said transaction server receives said transaction characteristics from said purchaser interface;
wherein said transaction server transmits at least two said transaction characteristics to said tax server through said network connection; and
wherein said tax server generates a tax calculation from at least two said transaction characteristics and transmits said tax calculation to said transaction server through said network connection.

2. The system of claim 1, wherein said tax calculation is transmitted from said transaction server to said purchaser interface through said network connection before said transaction is finalized.

3. The system of claim 1, wherein said network connection is through a plurality of Internet addresses.

4. The system of claim 1, further including a plurality of transaction servers.

5. The system of claim 1, further including:
a merchant interface associated with said transaction server; and
a rules database in said tax server;
wherein said rules database is configured by said merchant interface; and
wherein said tax server generates said tax calculation in accordance with said rules database.

6. The system of claim 6, wherein said rules database includes a plurality of tax rules for a plurality of merchants.

7. The system of claim 1, said tax server including a subscription database, wherein said tax server generates said tax calculation in accordance with said subscription database.

8. The system of claim 1, further comprising a zone-level database accessible by said tax server, wherein said tax server generates said tax calculation with said zone-level database.

9. The system of claim 8, wherein said zone-level database is a zip code database storing a plurality of nine-digit zip codes.

10. The system of claim 1, further comprising a government computer, wherein said tax calculation is sent to said government computer by said tax server.

11. The system of claim 10, further comprising a tax payment in the amount of said tax calculation, wherein said tax payment is sent to said government computer.

12. The system of claim 1, further comprising a destination-based heuristic, wherein said tax calculation is generated with said destination-based heuristic.

13. The system of claim 1, wherein said plurality of transaction characteristics includes at least two of: a location, a classification, and a cost.

14. The system of claim 1, wherein said tax calculation is generated automatically without human intervention.

15. A tax calculation system, comprising:
a setup page residing on a first computer system;
a transaction page residing on a second computer system;
a tax calculation program residing on said first computer system;
wherein said setup page provides for the receipt of a plurality of merchant tax rules;
wherein said transaction page provides for the receipt of a plurality of transaction characteristics; and
wherein said tax calculation program creates a tax calculation from said plurality of merchant rules and said plurality of transaction characteristics.

16. The system of claim 15, wherein said setup page provides for the receipt of said merchant tax rules from a plurality of merchant computers.

17. The system of claim 15, wherein said plurality of merchant tax rules are used in a plurality of tax calculations.

18. The system of claim 17, wherein said plurality of merchant tax rules are used in a plurality of tax calculations without modification.

19. The system of claim 15, further comprising an exemption database.

20. The system of claim 19, said exemption database including at least two geographical levels of exemptions.

21. The system of claim 19, said exemption database including a hierarchy of jurisdictions that is four levels deep.

22. The system of claim 15, further comprising a location identification module, wherein said location identification module creates a nine-digit zip code from said transaction characteristics, and wherein said tax calculation is generated in accordance with said nine-digit zip code.

23. A method of calculating transaction-based tax calculations on a server that is remote from the server processing the transaction, comprising:
interacting with a setup web page to create a plurality of reusable merchant-specific tax rules;
storing said plurality of reusable merchant-specific tax rules on a predefined tax rules database storing merchant-specific tax rules for more than one merchant; and
receiving a data string comprising a plurality of transaction characteristics; and
invoking a tax calculator program to generate a tax calculation upon receipt of said data string in accordance with said merchant-specific tax rules.

24. The method of claim 23, wherein the setup web page is located on a tax server and wherein said data string originates from a web page located on a transaction server.

25. The method of claim 24, wherein said tax calculator program resides on said tax server.

26. The method of claim 24, wherein said tax server is at a remote location from said transaction server and wherein said tax server is controlled by an entity that does not control the transaction server.

27. The method of claim 23, further comprising querying an exemption database to determine whether a particular transaction or part of a transaction is a tax-exempt transaction.

28. The method of claim 27, wherein said database stores exemption data at multiple geographical levels.

29. The method of claim 28, wherein said database stores exemption data at a country-level exemption, a state-level exemption, a county-level exemption, a city-level exemption, and a zone-level exemption.

30. The method of claim 27, further comprising searching the exemption database to determine whether a customer is tax exempt.

31. The method of claim 23, further comprising providing a tax report to a government computer.

32. The method of claim 31, further comprising transmitting a tax payment to a government computer.
